(19) United States
(12) Patent Application Publication
(10) Pub. No.: US 2022/0375116 A1
(43) Pub. Date: Nov. 24, 2022

(54) MEASURING CHANGE IN TUMOR VOLUMES IN MEDICAL IMAGES

(71) Applicant: Genentech, Inc., South San Francisco, CA (US)

(72) Inventors: Jasmine PATIL, South San Francisco, CA (US); Alexander James Stephen CHAMPION DE CRESPIGNY, South San Francisco, CA (US); Richard Alan Duray CARANO, South San Francisco, CA (US)

(73) Assignee: Genentech, Inc., South San Francisco, CA (US)

(21) Appl. No.: 17/850,474

(22) Filed: Jun. 27, 2022

Related U.S. Application Data
(63) Continuation of application No. PCT/US2020/066083, filed on Dec. 18, 2020.
(60) Provisional application No. 62/958,926, filed on Jan. 9, 2020.
(60) Provisional application No. 63/017,946, filed on Apr. 30, 2020.

(51) Int. Cl. G06T 7/62; G06T 7/30; G06T 7/70; G06T 7/00; G06T 7/11

(52) U.S. Cl. CPC G06T 7/62; G06T 7/30; G06T 7/70; G06T 7/0014; G06T 7/11; G06T 2207/30096; G06T 2207/20092

(57) ABSTRACT

Techniques disclosed herein facilitate tracking the degree to which a size of a biological structure changes over time. In some instances, an initial biological image (collected at a first time) can be segmented to characterized a boundary and size. A subsequent biological image can be processed to identify a deformation and/or transformation variable (e.g., one or more Jacobian matrices and/or one or more Jacobian determinants). The deformation and/or transformation variable(s) and initial segmentation can be used to predict a size of the biological structure at a subsequent time. The predicted size may inform a treatment recommendation.

### CROSS-REFERENCE TO RELATED APPLICATIONS

This application is a continuation of PCT/US2020/066083, filed on Dec. 18, 2020, which claims priority and benefit from U.S. Provisional Application No. 62/958,926, filed on Jan. 9, 2020 and U.S. Provisional Application No. 63/017,946, filed on Apr. 30, 2020, the entire contents of which are incorporated herein reference for all purposes.

### BACKGROUND

Cancer is a leading cause of death across many nations. Identifying effective treatment entails both effectively diagnosing an initial condition and also effectively characterizing a degree of efficacy of each treatment administered to a subject so as to provide opportunity to change and/or tailor treatment strategies.

For example, statistics from the American Cancer Society show that lung and bronchial cancer has been a leading cause of deaths in the United States of America with an estimate of 228,150 new cases and 147,670 deaths in 2019. The cost of developing an approved cancer drug is estimated to be between $200 million and $2.9 billion. However, evaluating the efficacy of newly developed cancer therapeutics can involve labor-intensive manual review of collected data, which increases the cost and time expenditure of the evaluation.

For example, images (e.g., CT images) can be analyzed to monitor target tumors using the RECIST criteria. The RECIST criteria stipulates that the longest axial diameter of the tumor is to be used as the parameter to monitor the progression of solid tumors. The efficacy of the experimental drug is then computed based on the change in diameter of the tumor.

Considering the change in diameter works well for ellipsoidal tumors. However, for non-ellipsoidal tumors, the change in volume of the tumor after drug delivery is a better indicator of drug efficacy. For non-ellipsoidal tumors, measurement of the largest diameter can correspond to a completely different change in the tumor volume. Measurement of tumor volume is also being explored as a possibly more sensitive outcome metric for clinical trials in oncology. Change in volume can be measured by delineating a particular lesion at baseline and follow up. This manual segmentation task is time consuming and is user dependent and hence error prone. Further, manual segmentation frequently involves recruiting input from a trained professional, which can add expense.

Thus, it would be advantageous to identify an automated approach for reliably and accurately track tumor volumes.

### SUMMARY

In some embodiments, techniques are disclosed for tracking a volume of a biological structure using images collected at different time points and using an outline of the biological structure generated from a single one of the images.

For example, a baseline image (e.g., a three-dimensional image) that depicts a tumor can be collected at a baseline time point. The tumor can be delineated (e.g., segmented) by a human annotator, so as to define a mask for the baseline time point. The delineation may be performed using one or more semi-automated segmentation tools. Another “subsequent” image (e.g., three-dimensional image) depicting the tumor at a subsequent time can be processed to estimate the volume (or volume change) of the tumor at the subsequent time. The processing can include performing a non-linear registration, such that individual points, boundaries or other geometrical features on the subsequent image(s) are associated with corresponding features in the initial image. Relationships between the original and subsequent features (e.g., distances between points, warping between lines, etc.) and a size of the tumor at the baseline time point can be used to estimate the size of the tumor at the subsequent time. The relationships may also or alternatively be used to estimate a segmentation and/or mask for the subsequent image. Thus, the size of the tumor at the subsequent time may be estimated without delineating, segmenting or annotating the tumor in the subsequent image. Such an approach may improve efficiency; reduce or eliminate a reliance on using anatomical landmarks; and/or reduce the extent to which successive assessments are erroneous due to different types of subjective characterizations. The volume tracking can be used to (for example) estimate a current or predict a future disease progression, evaluate an efficacy of a particular treatment and/or inform a selection of a new treatment.

In some embodiments, a computer-implemented method is provided. A first image is accessed. The first image depicts a part of a subject and may have been captured at a first time. A mask for the first image is generated. The mask outlines a particular biological structure depicted within the first image. A second image is accessed. The second image can depict a similar part of the subject and may have been captured at a second time that is after the first time. The second image is registered to the first image. For each voxel of at least some voxels within the mask, a transformation variable is calculated using the registration. The transformation variable characterizes a displacement (e.g., spatial difference) between a first position of the voxel within the first image and a second position of a corresponding voxel within the second image. A size of that the biological structure was at the second time is estimated using the transformation variables. The estimated size that the biological structure was at the second time is output.

In some instances, calculating the transformation variable includes calculating, using the registration, a spatial Jacobian matrix for the voxel; and calculating a Jacobian determinant for the voxel using the spatial Jacobian matrix for the voxel, wherein the estimated size of the biological structure at the second time is generated using the Jacobian determinant for the voxel.

In some instances, generating the estimated size of the biological structure can include summing the Jacobian determinants across the voxels of the plurality of voxels within the mask.

In some instances, generating the estimated size of the biological structure can include averaging the Jacobian determinants across the voxels of the plurality within the mask, and estimating the size that the biological structure was at the second time can include determining a product of the average of the Jacobian determinants across the voxels of the plurality within the mask with an estimated volume of the biological structure at the first time.

In some instances, the registration of the second image to the first image can use a non-linear B-spline transformation.

In some instances, identifying the mask for the first image can include processing detected user input that defined the outline of the particular biological structure.

In some instances, each of the first image and the second image can include a CT scan, an MRI image or an x-ray.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure is described in conjunction with the appended figures:

FIG. 1 shows an exemplary tumor tracking network according to some embodiments.

FIG. 2 shows a flowchart of a process for estimating a size of a tumor according to some embodiments.

FIG. 3 shows a demonstration of using the Jacobian determinant matrix to calculate the volume of the follow up volume according to some embodiments.

FIG. 4 shows exemplary data illustrating a comparison of volume change calculated using the Jacobian approach and the actual volume change.

FIG. 5 illustrates an exemplary CT lung-registration pipeline with data from an example Subject A.

FIG. 6 illustrates an overlay of a baseline axial slice and a follow-up slice corresponding to CT images of three subjects' lungs.

FIG. 7 illustrates a registration result for example Subject B.

FIG. 8 illustrates a registration result for example Subject C.

FIG. 9 shows the means and differences for paired volume-estimation values generated using manual annotation or by using the Jacobian determinant method, in accordance with one embodiment.

FIGS. 10A, 10B, 10C and 10D show comparisons between volume changes calculated using an embodiment of the Jacobian determinant method and actual volume change in lung lesions.

FIG. 11 shows an example of poor annotation from a radiologist annotator.

FIG. 12 shows a comparison of volume change calculated using an embodiment of the Jacobian determinant method and actual volume change in lung lesions with change in volume<30%.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### I. Overview

Systems, methods and software disclosed herein can facilitate reducing the time commitment, cost and errors involved while monitoring and characterizing tumors. More specifically, an annotation of a tumor in a first baseline image and a subsequent image may be used to predict a size (e.g., volume) of the tumor at a time at which the subsequent image was collected. The size may be estimated by (for example) registering the subsequent image to the first baseline image, automatically determining one or more deformation variables (e.g., one or more Jacobian matrices and/or one or more Jacobian determinants), and collecting processing deformation variables and annotations performed using the first baseline image.

More specifically, a baseline image that depicts a part of a body of a subject can be collected using an imaging device at a first time point. The subject may include a subject who has been diagnosed with cancer (e.g., lung cancer, bronchial cancer, breast cancer, prostate cancer, colorectal cancer, or any other type of cancer), and the part of the body may depict part or all of one or more tumors.

The baseline image can be transmitted to and presented at an annotator's device (e.g., a radiologist's device). Input received at the annotator's device can be used to identify which part(s) of the baseline image correspond to a particular biological structure. For example, the input can correspond to a border of the particular biological structure. In some instances, a volume of the biological structure can be estimated based on the baseline image and the border. A mask can be generated using the border (e.g., such that each voxel within the border is assigned a value of “1” and each voxel outside the border is assigned a value of “0”).

Another image can depict a similar or same part of the subject's body but may be collected at a subsequent time point (e.g., a defined number of days, weeks, months or years after the first time point). The other image can be registered to the baseline image. The registration may be performed using a spline registration (e.g., B-spline registration), an affine transformation or a transformation based on joint entropy or mutual information. In some instances, prior to registration of the other image, the baseline image can be cropped around the depicted biological structure (e.g., using a box shape that extends to a particular margin, such as a 30-voxel margin around a maximum length and width of the depicted biological structure). This cropping may reduce the time and processing commitment for performing the registration.

The registration can be used to identify a deformation field that includes a vector image with each voxel containing a displacement vector. A spatial Jacobian matrix can be defined as the first-order derivative of the deformation field. A determinant of the Jacobian matrix can indicate a degree of local compression or expansion (with values less than 1 indicating local compression and values greater than 1 indicating expansion). The voxel-specific determinants can be multiplied with the mask, and an average across pixels can predict a change in volume of the biological structure. This change can be multiplied with an estimated volume of the biological structure at the first time point to estimate a volume change of the biological structure at the subsequent time point. The volume change and a volume at the baseline time point can be used to estimate a volume of the biological structure at the subsequent time point.

A volume of a biological structure can be estimated across time points while only using a border detection at a single time point. Thus, when the border is defined based on input provided by an annotator, such input need only be received for a single image and/or image(s) associated with a single time point. This can reduce the expense and time expended for tracking a size of a biological structure. Further, the automated approach can reduce inconsistencies in object detection.

The baseline image and/or subsequent image can include a CT image, Mill image or x-ray. The biological structure can include a tumor, lesion, cell type, vasculature, etc. The baseline and subsequent images may, but need not, be collected by a same imaging device and/or a same type of imaging device.

In some instances, a condition is evaluated to determine whether to estimate a tumor volume for a subsequent time point without relying on an annotation for the subsequent time point (e.g., and instead using a Jacobian-based approach performed using data from a registration of an image from the subsequent time point to an image from a baseline time point). For example, the condition may indicate that the Jacobian-based approach is to be used when the first time point corresponding to the baseline image and the subsequent time point corresponding to the other image are within a predefined duration. As another example, the condition may indicate that the Jacobian-based approach is to be used when a metric indicative of a quality or confidence of a registration of the other image to the baseline image exceed a predefined threshold.

### II. Exemplary Tumor Tracking Network

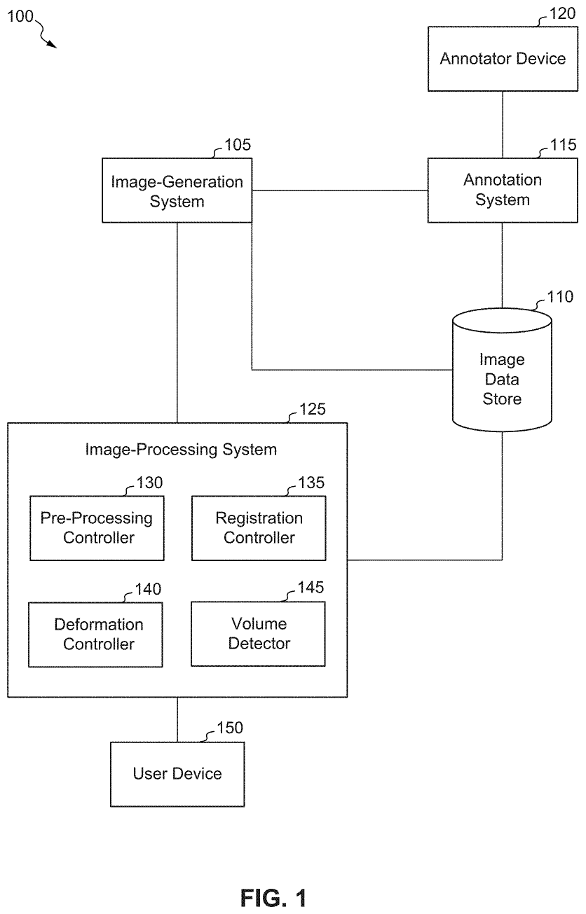

FIG. 1 shows an exemplary tumor tracking network 100 according to some embodiments. Tumor tracking network 100 includes an image-generation system 105 configured to collect one or more image of a part of a body of a subject. The image(s) may include one or more two-dimensional images or one or more three-dimensional images. Image-generation system 105 may include (for example) a computed tomography (CT) scanner or a magnetic resonance imaging (MM) machine. In some instances, image-generation system 105 may initially collect a set of two-dimensional images and generate a three-dimensional image using the two-dimensional images.

The image(s) collected by image-generation system 105 may be collected without a contrast agent having been administered to a subject or after a contrast agent was administered to a subject. The subject being imaged may include a subject who was diagnosed with cancer, who has a possible diagnosis or preliminary diagnosis of cancer and/or who has symptoms consistent with cancer or a tumor.

Image-generation system 105 may store the collected images in an image data store 110, which may include (for example) a cloud data store. Each image may be stored in association with one or more identifiers, such as an identifier of a subject and/or an identifier of a care provider associated with the subject. Each image may further be stored in association with a date on which the image was collected.

In some instances, one or more images are further availed to an annotation system 115, which can facilitate identifying annotations of one or more tumors depicted within the image(s). Annotation system 115 may control and avail an annotation interface that presents part or all of one or more images and that includes an input component to identifying one or more boundaries, perimeters and/or areas. For example, annotation system 115 can include a “pencil” or “pen” tool that can be positioned based on input and can produce markings along an identified boundary. In some instances, annotation system 115 facilitates identifying closed shapes, such that small gaps within a line segment are connected. In some instances, annotation system 115 facilitates identifying potential boundaries via (for example) performing an intensity and/or contrast analysis. Thus, annotation system 115 may support tools that facilitate performing semi-automated segmentation. Annotation system 115 can be a web server that can avail the interface via a website.

The annotation interface may be availed to an annotator device 120, which may be associated with, owned by, used by and/or controlled by a human annotator. The annotator may be (for example) a radiologist, a pathologist or an oncologist. Annotator device 120 may receive inputs from an annotator user and may transmit representations of the inputs (e.g., identifications of a set of pixels) to annotation system 115. Annotation system 115 can cause a representation of the annotation to be stored (e.g., in image data store 110). The representations may include (for example) a set of pixels and/or a set of voxels.

The annotation can be used to generate a mask for the baseline image. The mask can include binary values that are set to 0 outside of an annotated boundary and to 1 inside of the annotated boundary. A masked image may be generating by multiplying the mask with the original image.

Images that are annotated using annotation system 115 and annotator device 120 may include images obtained at one or more baseline time points. In some instances, a baseline time point is defined for each subject as a date on which one or more medical images (e.g., radiology images) were collected, where the one or more medical images depict one or more tumors. In some instances, a baseline time point is defined for each tumor and is defined as a first date on which a medical image depicted the tumor and/or a first date on which the tumor was identified and annotated in an image.

For each subject and/or for each tumor, image-generation system 105 (or another image-generation system) may collect one or more other images of the subject and/or tumor at a subsequent time that is after the baseline time point associated with the subject and/or tumor. In some instances, each subsequent image is processed automatically or semi-automatically to identify an annotation of each of one or more tumors. Automatic identification can be performed without being based on input from a human annotator. Semi-automatic identification can be performed based on input from a human annotator that falls short of a full annotation. For example, annotation system 115 may be configured to present an image and an input tool that is configured to be positioned and sized to identify a region that over-inclusively corresponds to a depiction of a tumor. The region may thus include a depiction of a tumor (e.g., a cross-section of a tumor or a three-dimensional volume of a tumor) and may further include depictions of one or more non-tumor biological structures. The input tool may include a box tool that is configured to be positioned and sized to demark a rectangular area, square area, cube volume, or cuboid volume.

An image processing system 125 (e.g., which may include a remote and/or cloud-based computing system) can be configured to predict, for each of one or more tumors, an annotation of the tumor that identifies a boundary of the tumor. Image-processing system 125 can include a pre-processing controller 130, which may initiate and/or control pre-processing of an image. The pre-processing may include (for example) cropping the image to a predefined size, modifying the image to have a predefined resolution, aligning multiple images, generating a three-dimensional image based on multiple two-dimensional image, generating one or more images having a different (e.g., target) perspective, adjusting (e.g., standardizing or normalizing) intensity values and/or adjusting color values. In some instances, for each tumor, pre-processing controller 130 generates a cropped image where an image is cropped to an area or volume (e.g., a rectangular area, a square area, a cuboid volume or cube volume) identified via input that indicated a region that included a depiction of the tumor. In some instances, for each tumor, pre-processing controller 130 generates a cropped image where an image is cropped to an area or volume that is set to be equal to a region identified via input (e.g., received at an annotator device 120) plus a buffer (e.g., that corresponds to a predetermined number of pixels or voxels). The cropping may be performed such that the cropped area or volume extends to an edge of the original image in instances where the buffer extension would extend past an image edge of the original image.

A registration controller 135 can register the image or a pre-processed version thereof to a corresponding baseline image. The registration can include (for example) using a deformable registration. The registration can include using a spline registration function (e.g., a B-spline registration), an affine transformation or a transformation based on joint entropy or mutual information).

A deformation detector 140 can use the registration to characterize a deformation between depictions of a tumor between the baseline and subsequent image. The registration may be configured to generate a continuous deformation field that indicates, for each pixel or voxel in the subsequent image (or pre-processed version thereof), a corresponding pixel or voxel in a baseline image and/or a vector indicating a positional difference between the positions of corresponding pixels or voxels in the baseline and subsequent images.

Deformation detector 140 can calculate one or more Jacobian matrices and/or one or more Jacobian determinants using (1) the annotation and/or mask associated with the baseline image; and (2) the registration. In some instances, a Jacobian determinant (or other deformation variable) is determined for each voxel.

A volume detector 145 can use the deformation variable (e.g., a Jacobian determinant) to predict a volume of a tumor at the subsequent time. For example, volume detector 145 may multiply, for each voxel in the subsequent image, the voxel-associated Jacobian determinant with a corresponding value of the mask generated using the annotation of the baseline image. Thus, a product can be generated for each voxel based on a corresponding deformation variable and a corresponding value in the mask.

Volume detector 145 can predict a volume change of the tumor at the subsequent time by generating a statistic based on the voxel-associated products. For example, a sum or average of the voxel-specific products can be generated, which may indicate a predicted change in volume between the baseline and subsequent time. An absolute volume at the subsequent time can be estimated to be a volume at the baseline time and the predicted change.

The predicted volume can be returned to a user device 150. User device 150 may include a device that requested an estimate of one or more tumors. User device 150 may be associated with a medical professional and/or care provider that is treating and/or evaluating a subject who is imaged. In some instances, image-processing system 125 may return an estimate of a volume of one or more tumors to image-generation system 105 (e.g., which may subsequently transmit the estimated volume to a user device).

In some instances, deformation detector 140 can use the deformation variables and the mask and/or annotation of the baseline image to predict precise locations of a boundary of the tumor in the subsequent image. An annotated version of the subsequent image may then be generated and may include the boundary overlaid on the image. The annotated version of the subsequent image may be availed to user device 150 and/or image-generation system 105 along with the volume estimate.

It will be appreciated that, in some instances, tumor tracking network 100 can be used to estimate a volume of each of multiple tumors at the subsequent time (e.g., using corresponding annotations and/or masks generated for the tumors at the baseline time). It will also be appreciated that techniques described herein may be used to estimate a size of one or more different types of biological objects other than a tumor. For example, techniques may be used to estimate a volume (and/or volume change) of a lesion (e.g., brain lesion) and/or an area of a mole.

### III. Exemplary Tumor Tracking Process

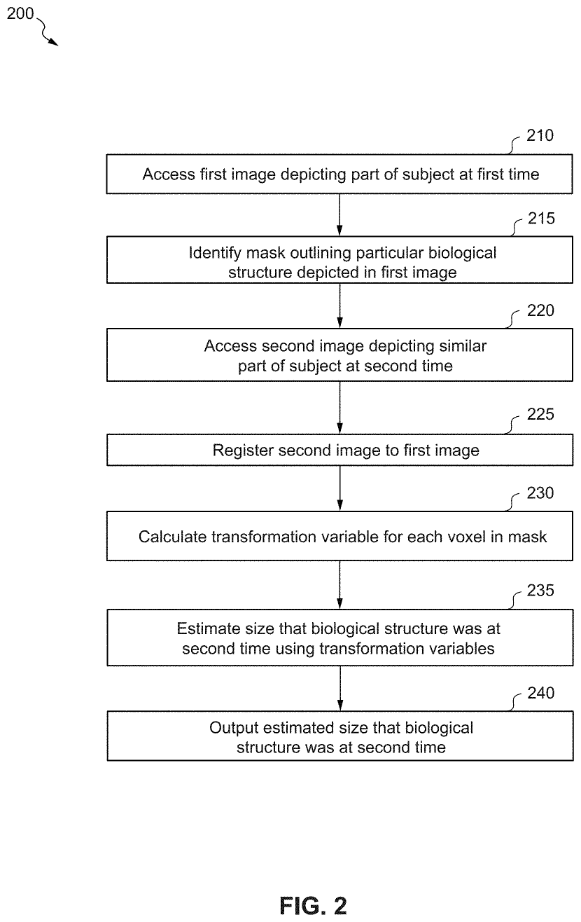

FIG. 2 shows a flowchart of a process 200 for estimating a size of a tumor according to some embodiments. Part or all of process 200 may be performed by an image-processing system, such as image-processing system 125 from network 100.

Process 200 begins at block 210 with accessing a first image. The first image can depict at part of a subject at a first time. The first image can depict at least part of a biological structure. The first image may be a two-dimensional image (e.g., depicting at least part of or all of a cross-section of a biological structure) or a three-dimensional (e.g., depicting at least part of or all of a volume of a biological structure). The subject may include a person who has been diagnosed with or has a possible diagnosis of a particular disease. The particular disease may be cancer and/or a particular type of cancer.

The first image may be an image collected at a baseline time. The baseline time can be a time at which a first image was collected that depicted a particular biological structure, a time at which a first image was collected that depicted a particular biological structure recognized by an annotator, and/or a time deemed to be a baseline for future comparison (e.g., by a human technician or care provider).

The first image may include a CT image, MRI image or x-ray image. The first image may include a radiological image. The first image may have been collected without a contrast agent was administered to the subject or after a contrast agent was administered to the subject.

At block 215, a mask outlining a particular biological structure is identified. The mask may be generated using annotation data that identifies a boundary of the biological structure. The annotation data may include and/or represent an annotation as identified via input from an annotator that indicates the boundary of the biological structure. For example, the annotator may have interacted with an interface that depicted one or more images corresponding to and/or including the first image so as to indicate the boundary.

The mask may be defined to be set to (for example) include values of zero across regions outside of the annotated biological-structure area or volume. The mask may be defined to include values of one across a region inside the inside annotated biological-structure area or volume. In some instances, the mask can be defined to be a value of one across a perimeter and/or boundary of the annotated biological-structure area or volume.

At block 220, a second image is accessed. The second image can depict a part of the same subject depicted (in part) in the first image accessed at block 210. The part of the same subject in the second image may be similar to the part of the subject depicted in the first image. For example, each of the first and second images may depict (e.g., in its entirety or in a cross-section) a same biological structure. In instances where the first and second images are two-dimensional images, a perspective of a second image may be the same or similar (e.g., within 30°, within 20° or within 10° along each of one, two or three perspective angles) of a perspective of the first image.

In some instances, the second image may be defined to be and/or may include a region indicated by a human user. The region may correspond to (for example) a rectangular and/or cuboid region. In some instances, each of the first image and the second image are to be a same size (e.g., a predetermined size), so a buffer may be introduced around the region to generate the second image of a target size.

The second image can include an image that was collected (for example) at least one week, at least one month, at least two months, at least three months, at least six months, at least one year or at least two years after the first time. The second image can include an image that was collected (for example) less than fifteen years, less than or equal to ten years, less than or equal to eight years, less than or equal to five years, less than or equal to three years, less than or equal to two years, less than or equal to one year, less than or equal to nine months, less than or equal to six months, less than or equal to three months, less than or equal to two months, or less than or equal to one month from the first time. For example, the second image may have been collected between six months and two years from the first time. The first and second images may be of a same type of image (e.g., CT image, MRI image or x-ray).

At block 225, the second image is registered to the first image. The registration can include (for example) performing an intensity-based image registration (e.g., using a correlation technique), a feature-based image registration, a transformation-based image registration, a spatial-domain registration and/or a frequency-domain registration. The registration can include using a registration function, such as a spline function (e.g., a B-spline function), an affine transformation or a transformation based on joint entropy or mutual information). The registration may be configured to determine—for each voxel of one or more voxels (or pixels) in the second image—to which voxel or pixel in the first image the voxel corresponds.

At block 230, one or more transformation variables can be calculated. In some instances, a transformation variable is calculated for each voxel (or pixel) within a mask defined for the first image (e.g., associated with a non-zero value in the mask), within an annotated boundary defined for the first image, and/or within the first image.

Calculating the transformation variable may include calculating a deformation field (e.g., using the registration). For example, the deformation field may indicate, for each voxel within all or part of the first image, an extent to which a depicted portion of a biological structure moved relative to other depicted portions or structures. As another (alternative or additional) example, the deformation field may include a set of displacement vectors (e.g., each corresponding to an individual voxel).

In some instances, a Jacobian matrix (e.g., a spatial Jacobian matrix) can be calculated for each voxel using the deformation field. A Jacobian determinant can be determined for each voxel using the Jacobian matrix. The Jacobian determinant can represent an extent to which a relative movement of a voxel from the first time to the second time. A value greater than 1 can represent local expansion, while a value less than 1 can represent local compression.

At block 235, a size of the biological structure at a second time at which the second image was collected is estimated. An estimated size difference of the biological structure between the first and second times may be calculating a sum or average of Jacobian determinants across a set of voxels. The set of voxels may include voxels within the mask identified in block 215 (e.g., where mask values are set to non-zero values). The estimated size difference may be added to a size of the biological structure at the first time produce an estimate of the size of the biological structure at the second time.

In some instances, values in the mask are used as weights to be applied to corresponding voxel so as to generate a weighted sum or weighted average. In some instances, a normalization is applied, where (for example) an interim result is normalized to generate the estimated size. The normalization can be performed using a size of a biological structure at a first time at which the first image was collected.

At block 240, the estimated size of the biological structure at the second time is output. The estimated size can be transmitted and/or displayed.

In some instances, rather than or in addition to outputting the estimated size of the biological structure, another result is determined based on the estimated size and is output. For example, an estimated cumulative size of multiple biological structures may be determined and output (e.g., by summing estimated sizes of each of multiple tumors). As another example, a potential treatment approach can be identified using a rule and an extent to which one or more biological structures have grown and/or shrunk.

In some instances, rather than or in addition to outputting the estimated size of the biological structure, a result is generated and/or output that predicts the degree to which a current treatment approach is effectively treating a cancer of the subject. For example, a rule may indicate that effective treatment is associated with a shrinkage of a tumor (or a cumulative shrinkage of all tumors) of at least a predefined threshold amount.

It will be appreciated that process 200 provides a technique that supports estimating recent sizes of biological objects without requiring detailed inputs from an annotator to identify precise boundaries of the objects in recent images. Rather, an identification of a general region is sufficient input (e.g., when combined with an annotation of the structure from a previous time and the automated processing). It will be appreciated that it is possible that additional biological structures (e.g., additional tumors) appeared between the first and second time. If an annotator detects a new structure, the annotator may be prompted to perform the full annotation, and a mask defined based on the annotation can be associated with a new baseline time point for the particular structure. In such cases, identifying a total count and/or cumulative size of a particular type of biological structures (e.g., tumors for a subject) may use both the sizes estimated using one or more transformation variables and one or more manual annotations.

### IV. Example

A registration technique was used to measure changes in lung tumors in subjects during therapy. The data set corresponded to 329 lung-tumor subjects. The initial tumor volume was estimated, and image-registration-based techniques were used to estimate changes in the volumes.

IV.A. Dataset

This retrospective study used CT scans from 329 subjects with stage 4 non-small cell lung cancer (NSCLC) who were enrolled in the Impower 150 trial (NCT02366143). Scans were collected between March 2015 to June 2019. The Impower 150 study had a total of 1201 subjects. Of these, 1068 subjects had lung lesions, of which 948 subjects had measurable lung lesions. Out of these 948 subjects, tumor volumetric data was available (based on central radiology assessment) for 353 subjects. Out of this cohort, volumetric measurements of lung lesions were obtained for 329 subjects for both baseline and follow up scans. Thus, the study subject set was defined to relate to these 329 subjects. Either the baseline scan or the follow-up scan was unavailable for each of the other 24 subjects.

For each subject in the study subject set, the subject was scanned on two days spaced six weeks apart. The scans were acquired at 260 sites globally. The first scan is referred to hereafter as the baseline scan, and the second scan is referred to as the follow-up scan.

IV.B. Methods

IV.B.1 Pre-Processing

Computed Tomography (CT) DICOM (Digital Imaging and Communications in Medicine) volumetric images were converted to the nifti (Neuroimaging Informatics Technology Initiative) format. During the conversion, images were resampled to a 1 mm isotropic resolution. The full dynamic range of Hounsfield units of CT scans was used for the experiments, and no normalization was performed on the values in the CT scans. Radiologists delineated lung lesion boundaries in the baseline and follow-up CT scans on up to 3 lesions in the lung (according to the RECIST 1.1 criteria) using semi-automated segmentation tools. These manually annotated boundaries provided masks for the lesions, which were used to calculate the ground truth tumor progression. In order to perform a local image registration, a region with a 30 mm boundary was cropped around the lesions.

IV.B.2 Registration

Image registration is the problem of finding a coordinate transformation T (x) that makes I_{M} (T (x)) spatially aligned with I_{F} (x), where I_{M} (x) is Moving Image and I_{F} (x) is Fixed Image. Spatially aligning the follow up image to the baseline image yields a deformation field. Each deformation field was represented as a vector image where each voxel contains the displacement vector in physical coordinates. The spatial Jacobian matrix is the first order derivative of the deformation field. The determinant of this Jacobian matrix (J) indicates the amount of local compression or expansion. Values smaller than 1 indicate local compression, values larger than 1 indicate local expansion, and values 1 indicates volume preservation.

In this example, a non-linear B-spline transformation T_{μ}(x) shown in equation (1) was used.

$${T}_{μ} ( x ) = x + {\sum }_{{x}_{k} ∈ {N}_{∞}} {p}_{k} {β}^{3} ( \frac{x - {x}_{k}}{σ} ) \qquad ( 1 )$$

where xₖ are the control points, β³ (x) is the cubic multidimensional B-spline polynomial, pₖ is the B-spline coefficient vectors, a is the B-spline control point spacing, and [symbol] ₓ is the set of all control points within the compact support of the B-spline at x.

SimpleElastix was used for non-linear B Spline registration. A transformation variable (e.g., a Jacobian determinant), calculated from non-linear registration, was used to calculate the tumor volume change.

Jacobian determinants are invariant to linear registration alignments, and that estimated change can characterize voxel-by-voxel volumetric spatial distribution. Using this determinant, a gross tumor volume identified only for the baseline time (and not at a follow-up scan) can be sufficient to estimate a gross tumor volume at subsequent time points after the baseline scan. This can eliminate the necessity of delineating the tumor boundary in the follow up scan.

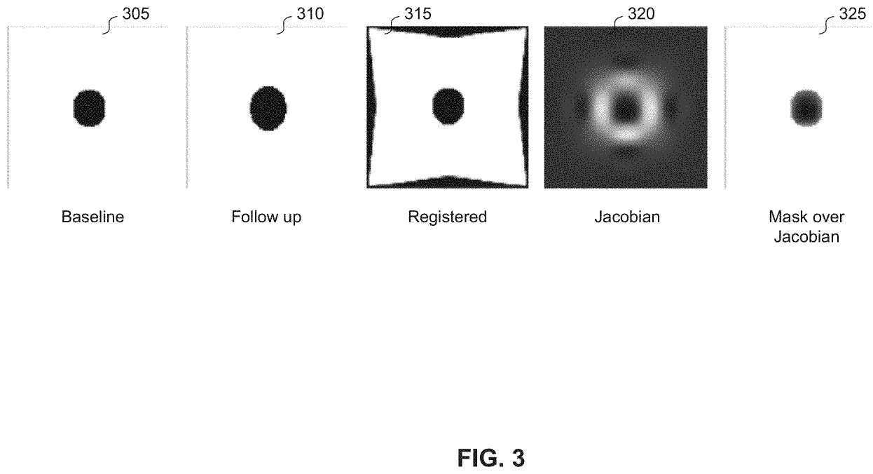

In order to demonstrate the utility of the Jacobian determinant in computing volume change, a synthetic dataset was created. The dataset containing baseline and follow-up ellipsoids with known volumes were processed such that follow-up ellipsoids were registered to the baseline ellipsoids. FIG. 3 shows a representative synthetic baseline image 305 and a synthetic follow-up image 310.

Volume changes between the baseline and follow-up were then calculated using the Jacobian determinant generated based on the registration. More specifically, each follow-up image was registered to a corresponding baseline image using a B-spline registration. Notably, in the exemplary instances depicted in FIG. 3, a size the ellipsoid in synthetic follow-up image 310 (6735 mm³) is larger than a size of the ellipsoid in synthetic baseline image 305 (4999 mm³). Thus, the actual change in volume is 1736 mm³.

However, it appears as though an ellipsoid in a registered version 315 of synthetic follow-up image 310 is approximately the same shape and size of that in synthetic baseline image 305 (as a result of the registration). For each voxel, a Jacobian determinant was calculated using a deformation vector that associated a voxel in registered version 315 with a corresponding voxel in synthetic follow-up image 310. A Jacobian matrix and a Jacobian determinant was then determined for the voxel using the deformation vector.

A Jacobian-determinant representation 320 indicates the Jacobian determinants associated with each voxel. A mask was defined to include values of one across voxels in the ellipsoid of synthetic baseline image 305 and values of zero across other voxels (thereby assuming a perfect annotation). The mask was multiplied (e.g., using a dot-product) with Jacobian-determinant representation 320 to produce a masked Jacobian representation 325.

Values within the mask were then summed to generate an estimated volume change using the Jacobian determinant, which was calculated to be 1746 mm³. For the representative instance shown in FIG. 3 (while the “true” volume difference for this exemplary instance.

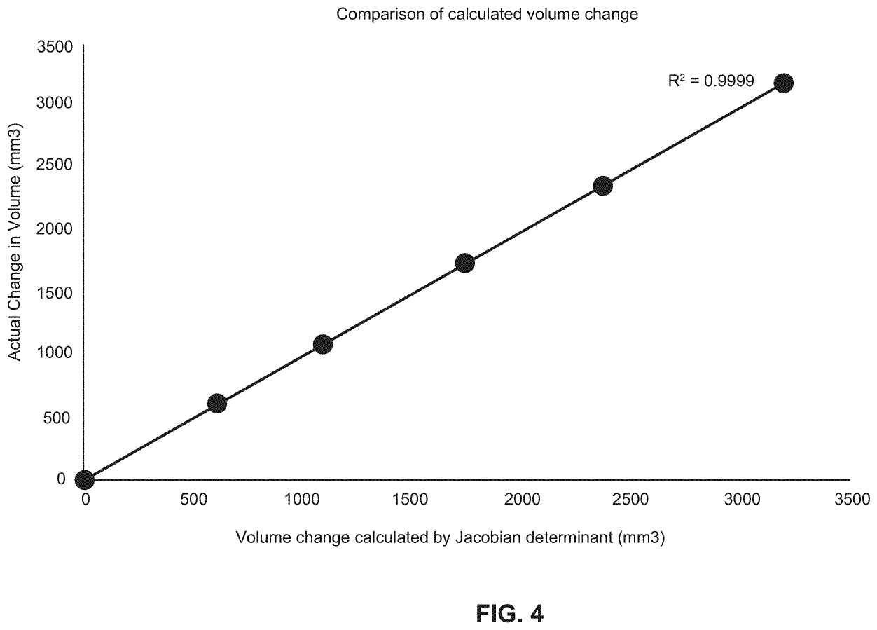

The actual volume change was compared to the Jacobian-calculated volume change for 5 different synthetic volumes. FIG. 4 shows the comparison of volume change calculate using the Jacobian-determinant technique identified in this Example and the actual volume change. The correlation between these two methods was 0.99.

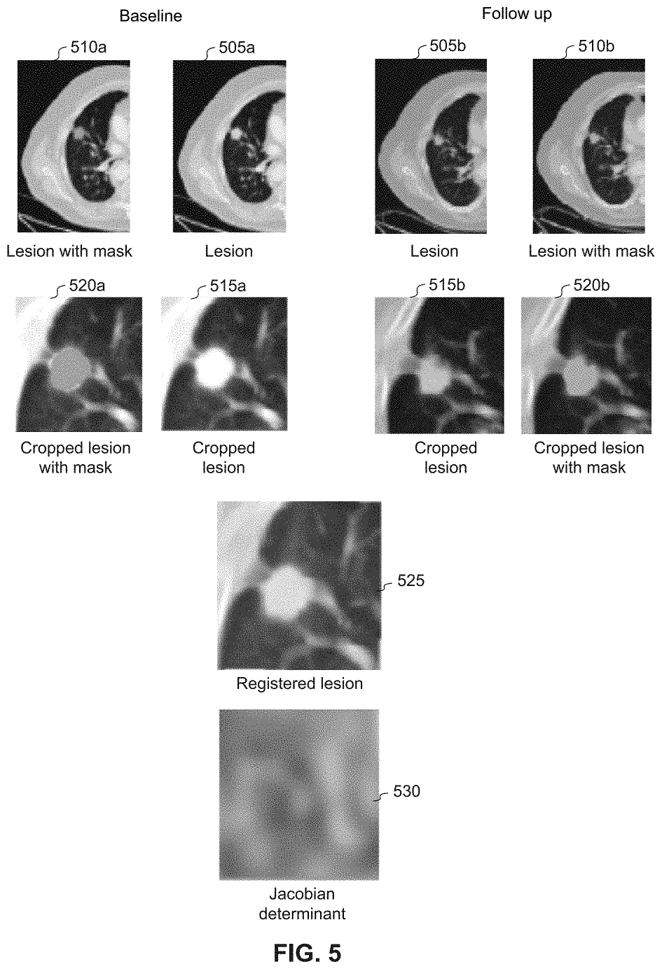

For CT lung lesions, a 30 mm bounding box was cropped around the lesion at baseline and follow-up scans. The follow-up scan was registered to the baseline scan. The Jacobian determinant of this transformation provides information on the expansion or shrinkage of all voxels in the baseline scan. FIG. 5 shows the pipeline of baseline and follow up image cropping and registration for a first exemplary subject (“Subject A”).

In particular, a baseline raw image 505a shows a CT image depicting a lesion, which is pronounced in a lesion-with-mask baseline representation 510a. A cropped baseline raw image 515a and a cropped lesion-with-mask baseline representation 520a include only some of the voxels corresponding to the full images. The mask was identified based on a radiologist's annotations.

Similarly, a subsequent raw image 505b shows a CT image depicting the lesion, where subsequent raw image 505b was obtained after a time at which baseline raw image 505a was obtained. The lesion from subsequent raw image 505b is pronounced in a lesion-with-mask subsequent representation 510b. A cropped subsequent raw image 515b and a cropped lesion-with-mask subsequent representation 520b include only some of the voxels corresponding to the full images.

A registration image 525 shows a version of cropped subsequent raw image 515b that has been transformed so as to be registered to baseline raw image 505a. Using registration data, a Jacobian determinant can be determined for each voxel (which are collectively represented in a Jacobian-determinant image 530).

Using the radiologist-annotated baseline mask (M_{B}) and the Jacobian determinant matrix (J), the change in volume of lesion at follow up scan was calculated using equation (2).

FUΔV=ΣM_{B}(J−1) (2)

IV.C. Results

IV.C.1 Registration Evaluation

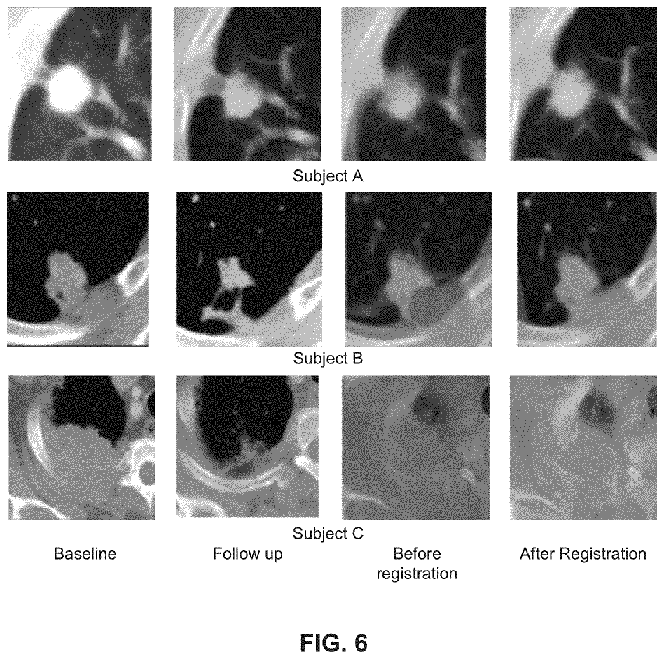

Registration results were qualitatively judged by visualizing registered images. The warped images looked similar to their corresponding baseline images. The registered image was subtracted from the baseline image and the difference was plotted as an image. Perfect registration would result in a difference image without any edges, and with just noise. Baseline scans and registered scans were displayed on top of each other to assess the difference between the images. FIG. 6 (left two columns of images) shows overlay of baseline & follow up before registration. Gray regions in the composite image show where the two images have the same intensities. Magenta and green regions show where the intensities are different. FIG. 6 (right two columns of images) shows baseline and registered image after registration of lung lesions. In Subject A & Subject B, registration was successful but Subject C registration failed, as shown by the results summarized in Table 1.

TABLE 1
Summary of Volume Calculation

| | | Follow up | Volume | Volume change |
|---|---|---|---|---|
| | | volume by | change by | calculated |
| | Baseline | radiologist | manual | using |
| | Volume | annotation | annotation | Jacobian |
| Example | (mm³) | (mm³) | (mm³) | determinant |
| Subject A | 1204 | 987 | −217 | −233 |
| Subject B | 4518 | 2452 | −2066 | −2060 |
| Subject C | 18110 | 1602 | −16508 | 8117 |

IV.C.2 Subject B

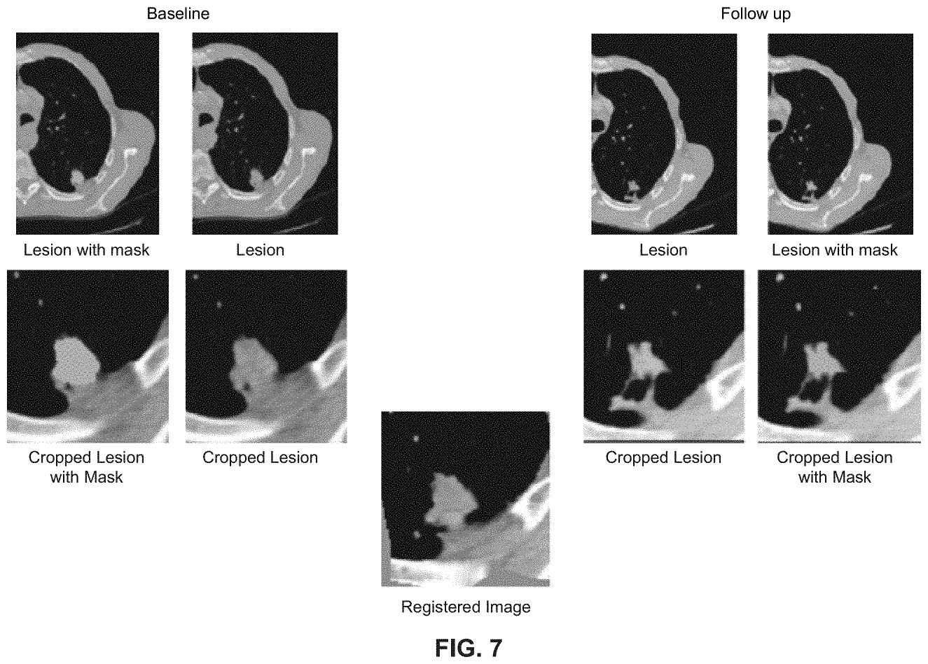

FIG. 7 shows another example of lesions, masks, cropping and registration that correspond to the types of images depicted in FIG. 5. However, the images of FIG. 7 pertain to a different subject (Subject B). In this instances, the volume of the lesion decreased at the follow up scan relative to the baseline scan. Lesion shrinkage is seen in the follow up image.

The volume change calculated by the Jacobian determinant method was −2060 mm3. This result was compared with the ground-truth volume change (measured by manually delineating the lesion in baseline and follow up images, and then subtracting their volumes). The ground-truth volume change was −2066 mm3, which compares well with the −2060 mm3 change predicted by the Jacobian method. The minus sign in the ground-truth volume change and the Jacobian-determinant change is indicative of lesion shrinkage.

IV.C.3 Subject C

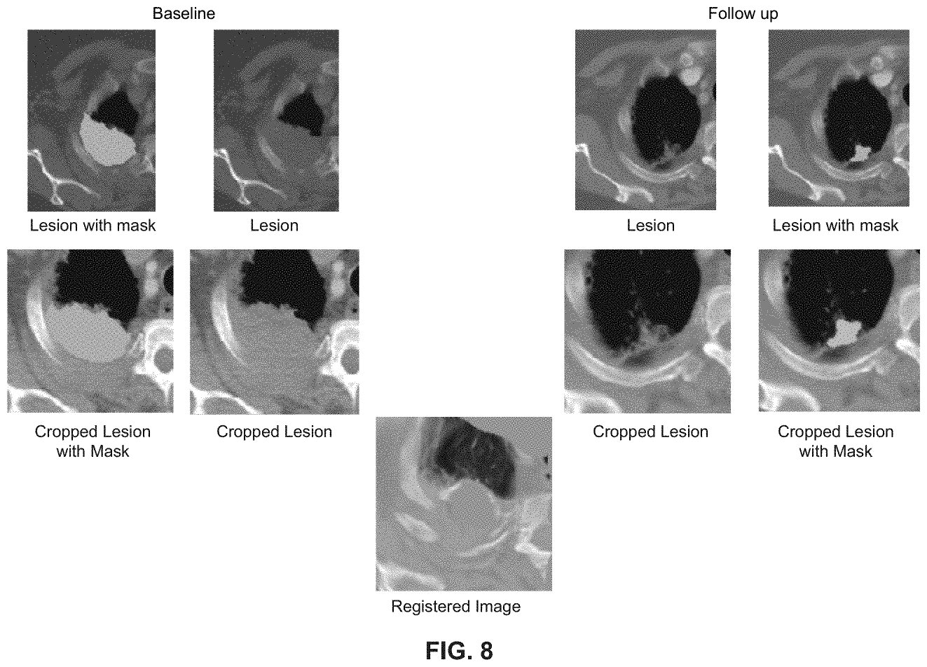

FIG. 8 shows yet another example of lesions, masks, cropping and registration that correspond to the types of images depicted in FIG. 5. However, the images of FIG. 8 pertain to yet another subject (Subject C).

In this particular instance, the nonlinear B-spline registration has failed. The ground-truth lesion volume change from baseline to follow-up was −91% (negative sign indicates lesion shrinkage). Due to non-correspondence in the volumes being registered, the registration axial slice does not look similar to baseline. In this case, the Jacobian-based approach predicted that the lesion grew (see Table 1), thus not matching the ground truth volume change (which indicated that the lesion, in fact, shrunk).

IV.C.4 High-Level Analysis

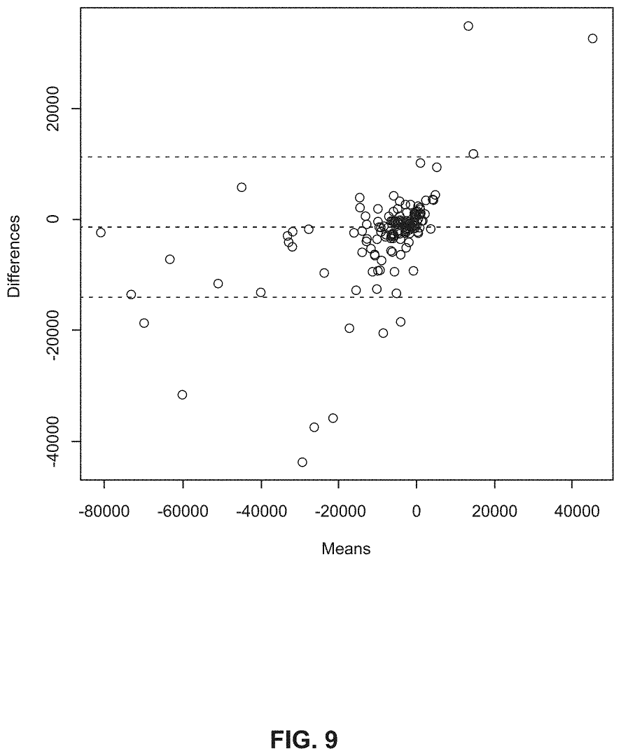

The volume change in 280 lesions was estimated using Jacobian determinants. FIG. 7 shows a Bland Altman plot. In this plot, for each lesion, a mean lesion-change value was calculated and plotted along the x-axis. Specifically, for each of the ground-truth instances and Jacobian-calculation instances, a lesion change was defined as a lesion size at a subsequent time minus a lesion size at a baseline time. For each subject, a mean value (“Mean”) was defined to be the mean of the lesion change calculated using the ground-truth annotations and the lesion change using the Jacobian technique. For each subject, a difference value (“Difference”) was defined to be the lesion change calculated using the manual annotations minus the lesion change calculated using the Jacobian technique. FIG. 9 plots the difference values relative to the mean values. Notably, many of the points are near the y=0 line, indicating high agreement between the Jacobian and ground-truth metrics.

Bland and Altman recommended that 95% of the data points should lie within 2 standard deviation of the mean difference. With regard to the analyzed data set, 11 subjects lie outside the 2 standard deviation limits. Hence 96.07% of the measurements lie inside the standard deviation interval.

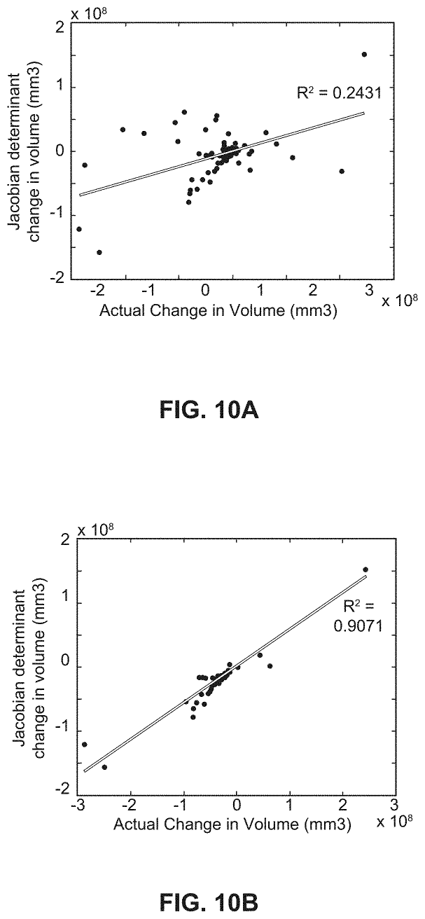

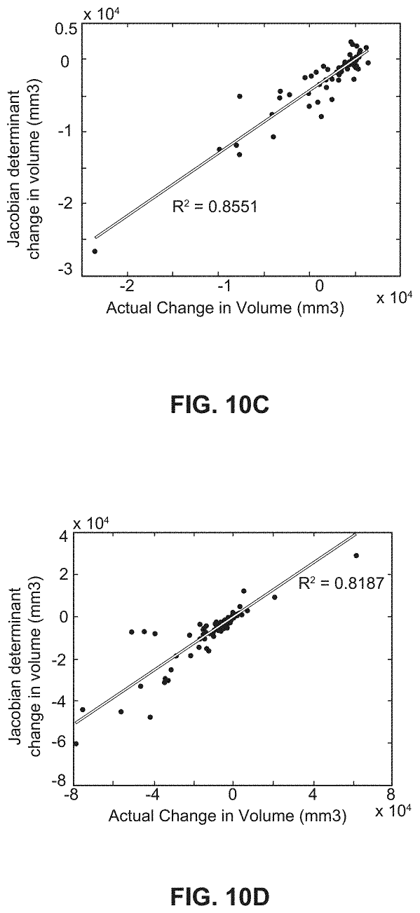

FIG. 10A shows a plot correlating statistics derived from manual annotation and statistics derived from Jacobian determinant method across all 329 lesions. The correlation between the two methods of measuring volume change is 0.24. The registration appeared to be sub-optimal particularly for lesions where the change in volume from baseline to follow up was more than 90%, so that the two volumes being registered were highly variable anatomically. Hence, 28 lesions were excluded as the change in volume was more than 90%. Upon manual inspection of registered volume, 33 lesions were excluded due to registration failures. Subject C in FIG. 6. is one of the examples of registration failure. FIG. 10B shows a plot correlating statistics derived from manual annotation and statistics derived from Jacobian determinant method on 268 lesions, when excluding registration failures and large volume changes.

Volume calculation using Jacobian determinant was more accurate when the actual change in volume were less than 40%. The registration of baseline and follow-up volumes have high image similarity when compared with the lesions where volume change were more than 40%. FIG. 10C shows a plot correlating statistics derived from manual annotation and statistics derived from Jacobian determinant method of lesions where change in volume is less than 40% (N=107). The correlation coefficient is 0.8861. FIG. 10D shows a plot correlating statistics derived from manual annotation and statistics derived from Jacobian determinant method of lesions where change in volume is more than 40% (N=161) with correlation coefficient of 0.8187.

IV.C.5 Selective Usage of Deformation-Based Approach

The transformation-based approach described herein may more accurately predict the size of biological structures and/or size changes of thereof in some circumstances relative to others.

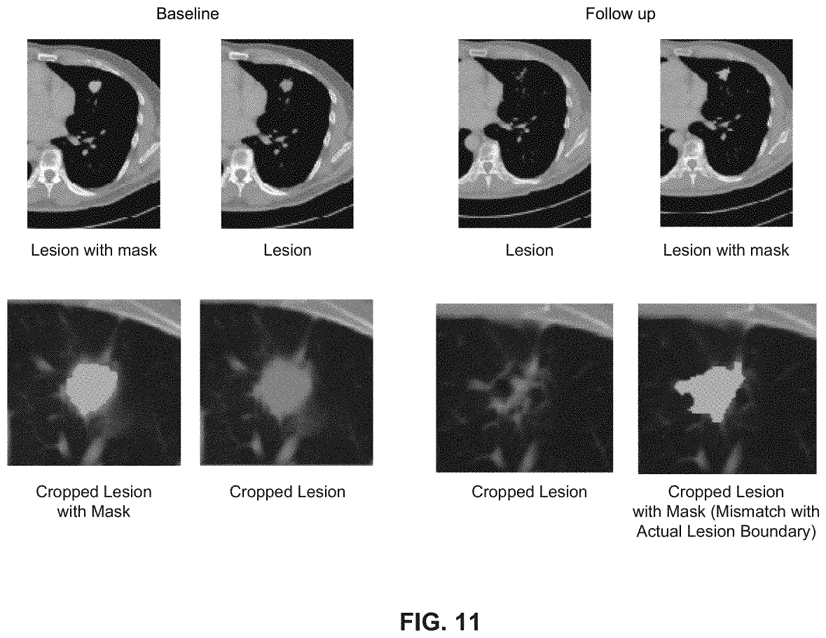

FIG. 11 shows one of the examples for which an annotation assessment by the radiologist at the follow up scan did not match the lesion boundary. The Jacobian determinant volume calculation shows a volume decrease of 1172 mm3. According to manual annotation, the tumor volume has increased by 14 mm3.

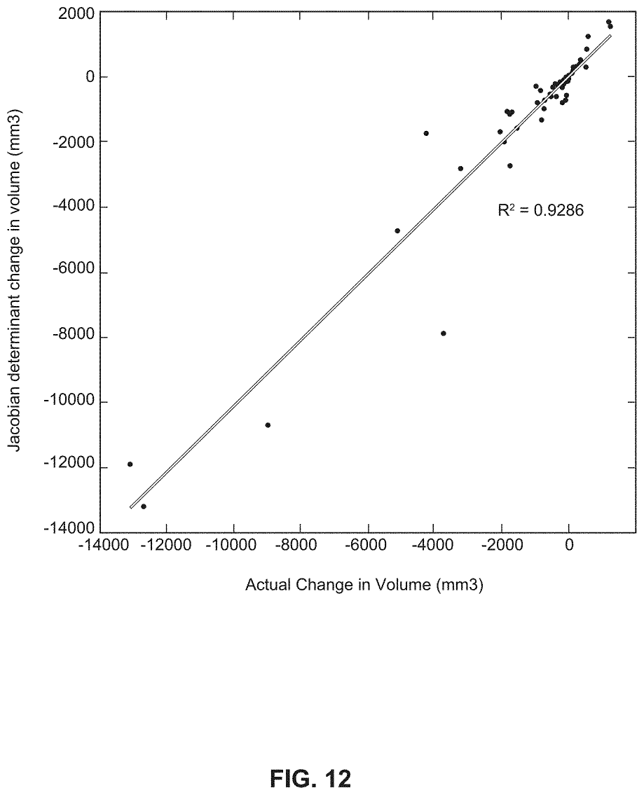

The Jacobian determinant method of measuring change is more efficient in measuring small changes in a lesion as compared to techniques that rely on repeated manual annotation. Registration of two volumes with small changes in lesion is successful when the anatomy is similar between baseline and follow-up scans. The Jacobian-based approach can be particularly advantageous for estimating lesion volumes when the scans are acquired at a small interval (less than 2 weeks). Short-term interval CT follow up scans are often used for enrollment criteria. FIG. 12 shows a plot of comparison of two methods when the volume change is less than 30%. Notably, the correlation between the predicted and observed lesion volume changes is well correlated for these data points (R2=0.9286).

Thus, it may be advantageous to use deformation-based approaches (e.g., that rely upon deformation fields, Jacobian matrices, etc.) so long as predicted changes in volume are below a predetermined threshold. In other circumstances, other evaluations of biological structures may be used (e.g., which may rely upon semi-automated or manual annotating of a biological structure at a subsequent time point).

IV.C. Discussion

The calculation of volume change at follow-up was semi-automated by processing a baseline scan, a follow-up scan and a baseline annotation. Precise Jacobian determinant matrix is dependent on the registration quality. Advanced Mattes Mutual Information was used as a similarity measure to characterize a quality of alignment of two volumes being registered. Confounding factors of the registration method include gross morphological change and large volume change. The Jacobian determinant calculated can include the anatomical changes along with the tumor change. Subject C's data illustrated that the registration can fail due to large volume change.

Registration evaluation was often performed by performing registration-based techniques, such as one that relies upon calculating Target Registration Error or DICE coefficient and/or or one that relies upon segmenting anatomical structures in images associated with each of multiple time periods. These two matrices require anatomical landmark points or segmentation of known anatomical structures on fixed and moving image. Manual annotation at baseline and follow-up to identify boundaries for volume estimation is time consuming, potentially expensive (due to paying for time of skilled professionals), and has the potential to introduce errors. To avoid these potential impacts, local volumes (with a 30 mm bounding box around particular lesions) were tracked using automated registration and size-characterization techniques. These approaches reduced the computation power required and also reduced the failure rate, relative to approaches that required iterative segmentation that involved human-annotator input (e.g., that indicated particular parts of both baseline and subsequent images that depicted at least a portion of a boundary of a biological structure).

### V. Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The description provides preferred exemplary embodiments only, and is not intended to limit the scope, applicability or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
accessing a first image depicting a part of a subject, the first image having been captured at a first time;
identifying a mask for the first image, wherein the mask outlines a biological structure depicted within the first image;
accessing a second image depicting a similar part of the subject, the second image having been captured at a second time subsequent to the first time;
registering the second image to the first image;
calculating, for each voxel of a plurality of voxels within the mask, a transformation variable using the registration, the transformation variable characterizing a spatial difference between a first position of the voxel within the first image and a second position of a corresponding voxel within the second image;
estimating a size that the biological structure was at the second time using the transformation variables; and
outputting the estimated size of the biological structure at the second time.

2. The computer-implemented method of claim 1, wherein calculating the transformation variable comprises:
calculating, using the registration, a spatial Jacobian matrix for the voxel; and
calculating a Jacobian determinant for the voxel using the spatial Jacobian matrix for the voxel, wherein the estimated size of the biological structure at the second time is generated using the Jacobian determinant for the voxel.

3. The computer-implemented method of claim 2, wherein generating the estimated size of the biological structure includes summing the Jacobian determinants across the plurality of voxels within the mask.

4. The computer-implemented method of claim 2, wherein generating the estimated size of the biological structure includes averaging the Jacobian determinants across the voxels of the plurality within the mask, and wherein estimating the size that the biological structure was at the second time includes:
determining a product of:
the average of the Jacobian determinants across the voxels of the plurality within the mask; and
an estimated volume of the biological structure at the first time.

5. The computer-implemented method of claim 1, wherein the registration of the second image to the first image uses a non-linear B-spline transformation.

6. The computer-implemented method of claim 1, wherein identifying the mask for the first image includes processing detected user input that defined an outline of the biological structure.

7. The computer-implemented method of claim 1, wherein each of the first image and the second image include a CT scan, an MM image or an x-ray.

8. A system comprising:
one or more data processors; and
a non-transitory computer readable storage medium containing instructions which, when executed on the one or more data processors, cause the one or more data processors to perform a set of actions including:
accessing a first image depicting a part of a subject, the first image having been captured at a first time;
identifying a mask for the first image, wherein the mask outlines a biological structure depicted within the first image;
accessing a second image depicting a similar part of the subject, the second image having been captured at a second time subsequent to the first time;
registering the second image to the first image;
calculating, for each voxel of a plurality of voxels within the mask, a transformation variable using the registration, the transformation variable characterizing a spatial difference between a first position of the voxel within the first image and a second position of a corresponding voxel within the second image;
estimating a size that the biological structure was at the second time using the transformation variables; and
outputting the estimated size of the biological structure at the second time.

9. The system of claim 8, wherein calculating the transformation variable comprises:
calculating, using the registration, a spatial Jacobian matrix for the voxel; and
calculating a Jacobian determinant for the voxel using the spatial Jacobian matrix for the voxel, wherein the estimated size of the biological structure at the second time is generated using the Jacobian determinant for the voxel.

10. The system of claim 9, wherein generating the estimated size of the biological structure includes summing the Jacobian determinants across the plurality of voxels within the mask.

11. The system of claim 9, wherein generating the estimated size of the biological structure includes averaging the Jacobian determinants across the voxels of the plurality within the mask, and wherein estimating the size that the biological structure was at the second time includes:
determining a product of:
the average of the Jacobian determinants across the voxels of the plurality within the mask; and
an estimated volume of the biological structure at the first time.

12. The system of claim 9, wherein the registration of the second image to the first image uses a non-linear B-spline transformation.

13. The system of claim 8, wherein identifying the mask for the first image includes processing detected user input that defined an outline of the biological structure.

14. The system of claim 8, wherein each of the first image and the second image include a CT scan, an MRI image or an x-ray.

15. A computer-program product tangibly embodied in a non-transitory machine-readable storage medium, including instructions configured to cause one or more data processors to perform a set of actions including:
accessing a first image depicting a part of a subject, the first image having been captured at a first time;
identifying a mask for the first image, wherein the mask outlines a biological structure depicted within the first image;
accessing a second image depicting a similar part of the subject, the second image having been captured at a second time subsequent to the first time;
registering the second image to the first image;
calculating, for each voxel of a plurality of voxels within the mask, a transformation variable using the registration, the transformation variable characterizing a spatial difference between a first position of the voxel within the first image and a second position of a corresponding voxel within the second image;
estimating a size that the biological structure was at the second time using the transformation variables; and
outputting the estimated size of the biological structure at the second time.

16. The computer-program product of claim 15, wherein calculating the transformation variable comprises:
calculating, using the registration, a spatial Jacobian matrix for the voxel; and
calculating a Jacobian determinant for the voxel using the spatial Jacobian matrix for the voxel, wherein the estimated size of the biological structure at the second time is generated using the Jacobian determinant for the voxel.

17. The computer-program product of claim 16, wherein generating the estimated size of the biological structure includes summing the Jacobian determinants across the plurality of voxels within the mask.

18. The computer-program product of claim 16, wherein generating the estimated size of the biological structure includes averaging the Jacobian determinants across the voxels of the plurality within the mask, and wherein estimating the size that the biological structure was at the second time includes:
determining a product of:
the average of the Jacobian determinants across the voxels of the plurality within the mask; and
an estimated volume of the biological structure at the first time.

19. The system of claim 15, wherein the registration of the second image to the first image uses a non-linear B-spline transformation.

20. The system of claim 15, wherein identifying the mask for the first image includes processing detected user input that defined an outline of the biological structure.
